(19) United States
(12) Patent Application Publication
(10) Pub. No.: US 2014/0156820 A1
(43) Pub. Date: Jun. 5, 2014

(54) CONFIGURATION INFORMATION SELECTION BASED ON EXTRACTED INFORMATION

(71) Applicant: HEWLETT-PACKARD DEVELOPMENT COMPANY, L.P., Houston, TX (US)

(72) Inventor: Gilbert Moineau, Montreal (CA)

(73) Assignee: HEWLETT-PACKARD DEVELOPMENT COMPANY, L.P., Houston, TX (US)

(21) Appl. No.: 13/690,975

(22) Filed: Nov. 30, 2012

(51) Int. Cl. H04L 29/08

(52) U.S. Cl. CPC H04L 29/08567
USPC 709/223

(57) ABSTRACT

A communication may be received and information related to a controlled device may be extracted from the received communication. One of a plurality of configuration information may be selected based on the extracted information. The selected configuration information may be transmitted to the controlled device for installation at the controlled device.

### BACKGROUND OF THE INVENTION

When a network device is installed on a network, the network device needs to be configured. The configuration for the device may differ based on, for example, where the device is to be located in the network. Typically, the device may be configured manually by an administrator.

### DRAWINGS

FIG. 1 is a diagram depicting an example of a system environment, according to at least one embodiment of the present disclosure.

FIG. 2 is a diagram of an example of a device within the system environment, according to at least one embodiment of the present disclosure.

FIG. 3 is a diagram of an example of a central controller, according to at least one embodiment of the present disclosure.

FIG. 4 is a flow diagram of an example of a method for generating a dynamic name according to at least one embodiment of the present disclosure.

FIG. 5 is a flow diagram of an example of a method for generating a topology map according to at least one embodiment of the present disclosure.

FIG. 6 is a diagram depicting an example of a topology map, according to at least one embodiment of the present disclosure.

FIG. 7 is a flow diagram of an example of a method for selecting and transmitting configuration information according to at least one embodiment of the present disclosure.

FIG. 8 is a diagram of an example of a central controller within the system environment, according to at least one embodiment of the present disclosure.

### DETAILED DESCRIPTION

When installing a controlled device on a network, typically an administrator may analyze information related to the controlled device, determine configuration information to be installed at the controlled device, and enable transmission of the configuration to the controlled device for installation. This creates an opportunity for errors on the part of the administrator where the incorrect configuration information may be installed. Further, where there are a large number of controlled devices to be installed, this process may be cumbersome.

### Overview

As discussed herein, configuration information may be selected and transmitted to a controlled device for installation. For example, a dynamic name of the controlled device may be received. Information related to the controlled device may be extracted from the dynamic name of the controlled device. The dynamic name of the controlled device may include information related to the controlled device, including information related to the location of the controlled device in the network. Configuration information may be selected from a plurality of configuration information based on the extracted information. The selected configuration information may be transmitted to the controlled device.

Also as discussed herein, a communication may be received from a controlled device at the time the controlled device is to be installed in the network. The communication may include, for example, a dynamic name of the controlled device, identifying information of the controlled device, for example, an IP address of the controlled device, including subnet information, a service set identifier (SSID) of a controlled device or a neighbor device, a media access control (MAC) address, etc., or information related to a neighbor device. Information may be extracted from the received communication. The information extracted from the received communication may relate to the location of the controlled device in the network. Configuration information may be selected from a plurality of configuration information based on the extracted information. The selected configuration information may be transmitted to the controlled device.

Thus, when a controlled device is to be installed in a network, configuration information may be selected by a controller device based on information related to the controlled device and transmitted to the controlled device for installation. This may avoid opportunity for errors by an administrator and enables fast configuration of controlled devices.

### System Environment

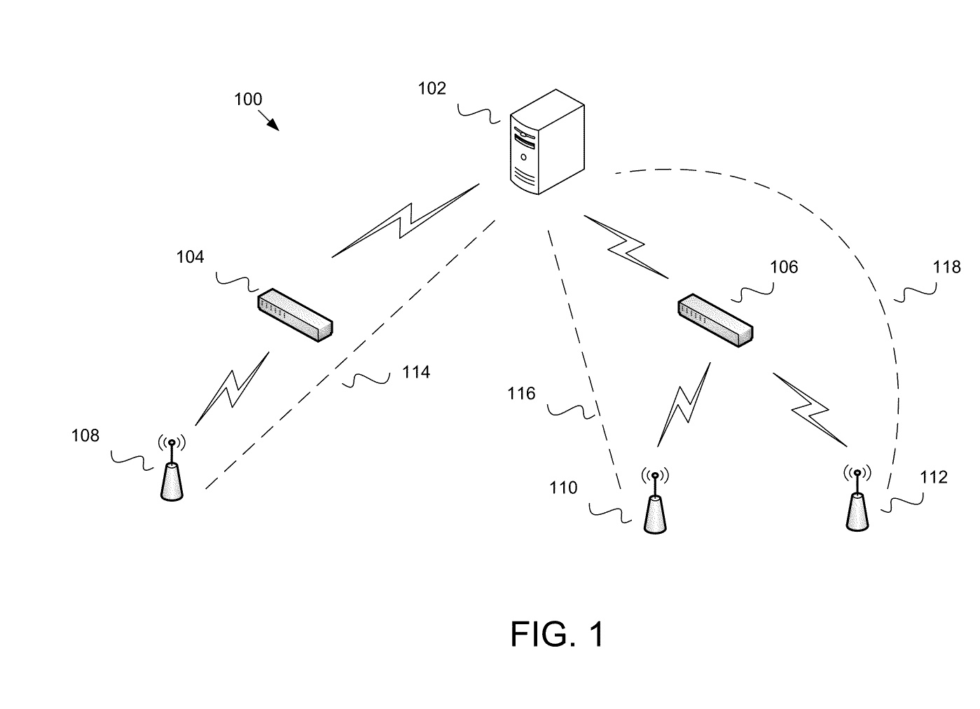

FIG. 1 depicts an example of a system environment. It may be appreciated that additional devices may reside within system 100. As shown in FIG. 1, system environment 100 includes central controller 102. Central controller 102 may be communicably linked to all the devices within system 100. Devices within system 100 may include, for example, central controllers, controlled devices, for example, access points, switches, routers, etc. Central Controller 102 may be implemented as a computing device, for example, a server computing device. Central controller 102 may enable a user, for example, an administrator, to view, access, maintain, control, etc., information regarding devices within system 100.

System 100 may further include switches 104, 106. Switches 104, 106 may facilitate communication between controlled devices, communication between controlled devices and central controller 102, etc. As switch 104 is a neighbor device of controlled device 108 and central controller 102, switch 104 may further communicate discovery protocol information to controlled device 108 and central controller 102. As switch 106 is a neighbor device of controlled devices 110, 112 and central controller 102, switch 106 may further communicate discovery protocol information to controlled devices 110, 112 and central controller 102.

System 100 may further include controlled devices 108, 110, 112. Controlled devices 108, 110, 112 may receive discovery protocol information from their respective neighbor switch. Controlled devices 108, 110, 112 may communicate information related to controlled device 108, 110, 112, respectively. For example, Controlled devices 108, 110, 112 may communicate information related to controlled devices 108, 110, 112, respectively, and may further communicate a dynamically generated name, or dynamic name, of controlled device 108, 110, 112, respectively, directly to central controller 102 via communication 114, 116, 118, respectively. Controlled devices 108, 110, 112 may further communicate to central controller 102, via discovery protocols through network devices such as switches, routers, etc., information related to the controlled devices.

It may be appreciated that information regarding devices' neighbors may be obtained in other ways, for example, via sniffing spanning tree packets received from neighbor devices.

### Central Controller

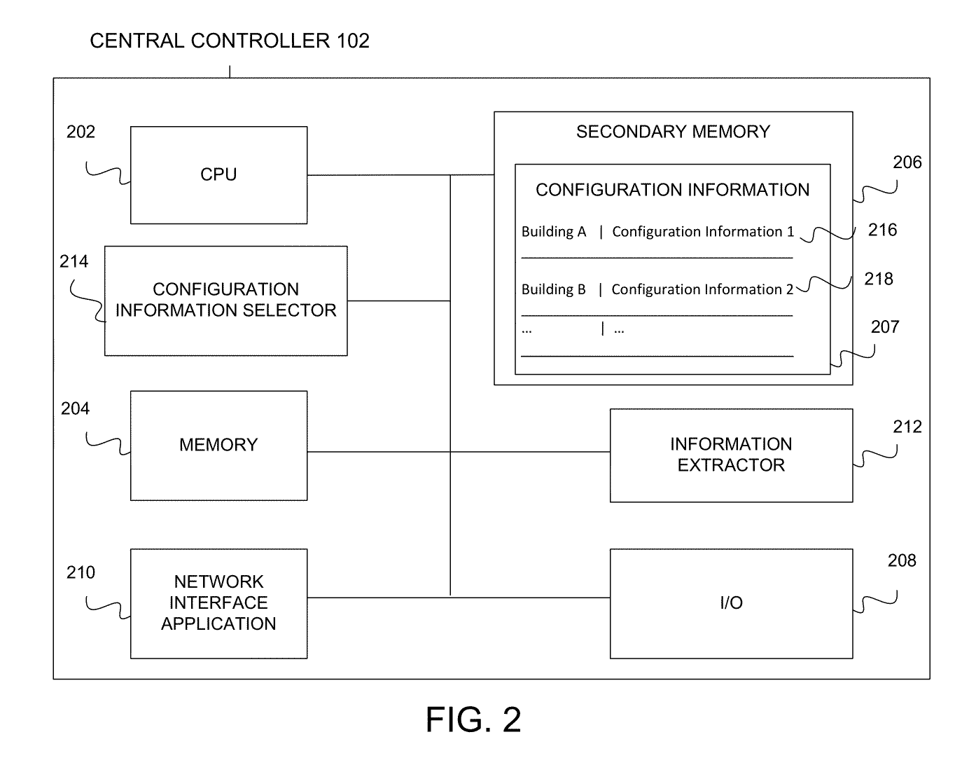

FIG. 2 depicts a block diagram of an example of central controller 102. It may be appreciated that central controller 102 may include additional components that are not depicted in FIG. 2.

As shown in FIG. 2, central controller includes central processing unit 202, memory 204, secondary memory 206, input/output (I/O) 208, network interface application 210, and configuration information selector 214. Central controller may further include a topology application (not shown). Central controller 102 may further include information extractor 212.

Secondary memory may include configuration information 207. Configuration information 207 may be implemented as a database, look-up table, etc., and may store configuration information for a plurality of groups in a network. As shown in FIG. 2, for example, configuration information 207 includes two groups, Building A 216 and Building B 218. Building A 216 has associated therewith configuration information 1. Building B 218 has associated therewith configuration information 2. It may be appreciated that additional, and/or different groups may be stored. Configuration information is information that may be installed on all devices that are associated with the group. For example, all controlled devices in Building A may have installed thereon configuration information 1. All controlled devices in Building B may have installed thereon configuration information 2.

Configuration information selector 214 may enable creation of, manage and/or access configuration information 207 in secondary storage 206. Configuration information selector 214 may further enable creation of, manage and access a script, generated by a user, for example, an administrator, to define rules for associating controlled devices to groups in a network. The script may be stored in secondary storage for access by configuration information selector 214, information extractor 212, etc.

For example, the following script may be generated by an administrator and include:
If <device IP address>/24=192.168.3.0 move AP to Group “Building A”
If <device IP address>/24=192.168.2.0 move AP to Group “Building B”

Thus, in this example, the controlled device is grouped based on the subnet on which the controlled device is installed.

In another example, the following script may be generated by an administrator and include:
a. If <device name> includes “Building A” move AP to Group “Building A”
b. If <device name> includes “Building B” move AP to Group “Building B”

Thus, in this example, the controlled device is grouped based on the information extracted from the dynamic name of the controlled device name. The dynamic name of a controlled device is discussed more fully below.

It may be appreciated that, alternative to an administrator creating a script, a graphical user interface (GUI) may be provided to the administrator. The GUI may include a plurality of selectable components, for example, in a pull down menu that enables the administrator to define rules for grouping controlled devices in the network. For example, a selectable component may provide the ability to select between identifying information of a controlled device, for example, the IP address, and therefore subnet, the SSID, the MAC address etc., of the controlled device or a neighbor device. Another selectable component may be provided in the GUI that enables the administrator to define the group associated with the each of the different types of identifying information, for example, Building A, Building B., etc. Once selected, a script may be generated and utilized in grouping controlled devices in a network.

Network interface application 210 enables communication between central controller 102 and all of the devices within system 100, including receiving and transmitting of communications between central controller 102 and other devices within the network.

Information extractor 212 may extract information from received communications from controlled devices in the network. For example, where a communication including a dynamic name is received from a controlled device, information extractor 212 may extract information related to the controlled device from the dynamic name by parsing the dynamic name based on a dynamic name definition as discussed below. Information extractor 212 may further extract subnet information from IP addresses of controlled devices, for example, based on a script generated by an administrator. This extracted information may be passed to configuration information selector 214 for configuration information selection.

Topology application is an application that generates a topology map including one or more devices within system 100. Topology application 212 may be implemented as, for example, ProCurve Manager software. This topology map may be generated by topology application 212 based on information topology application 212 accesses relating to each of the devices within system 100. This information may be stored in memory 204, secondary memory 206, memory remote to central controller 102, etc. This information relating to each of the devices within system 100 may include the dynamically generated name of the device, the device type, the device model, the device serial number, a physical location of the device, information relating to one or more neighbors of the device, etc.

### Controlled Device

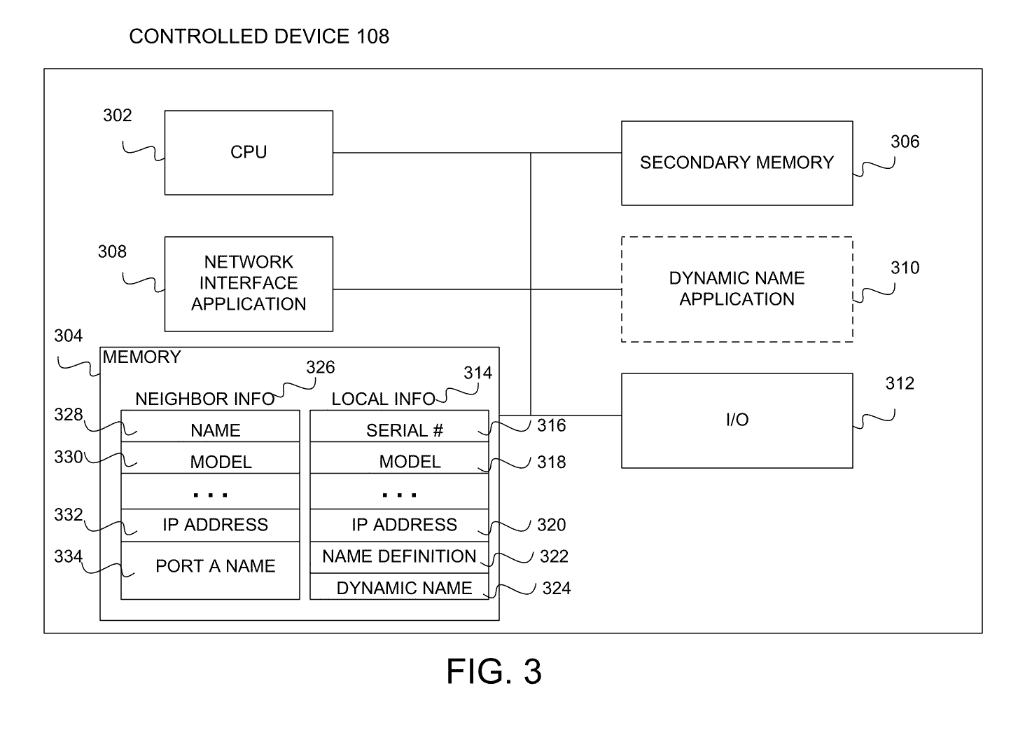

FIG. 3 depicts an example of a controlled device 108. It may be appreciated that controlled device 110 and controlled device 112 may include similar components and function similarly as discussed herein with regard to controlled device 108. As shown in FIG. 1, controlled device 108 includes CPU 302, memory 304, secondary memory 306, network interface application 308, optionally dynamic name application 310, and I/O 312.

1. Memory

Memory 304 may store local information 314 relating to the controlled device 108, itself. For example, controlled device 108 may store its serial number 316, model 318, internet protocol (IP) address 320, dynamic name definition 322, dynamically generated name 324, etc. The dynamic name definition 322 and dynamically generated name 324 are discussed below. In addition, memory 304 may store information related to the controlled device 108's neighbor, which is, in this example, switch 104. For example, neighbor information 326 may include the neighbor device's name 328, model 330, IP address 332, port A name 334 (the port to which communication is facilitated between switch 104 and controlled device 108), etc. This information may be received at controlled device 108 from the neighbor device, which is, in this example, switch 104, during a discovery process discussed below, or through other processes, for example, sniffing spanning tree packets.

2. Network Interface Application

Network interface application 308 enables communication between controlled device 108, switch 104, central controller 102, and with other devices within system 100. One type of communication that may be enabled between controlled device 108 and switch 104 may be through IEEE 802.1AB link layer discovery protocol (LLDP). LLDP defines a standard method for Ethernet network devices, such as switches, routers, wireless LAN access points etc., to advertise information about themselves to other nodes or devices on the network and to store the information they discover. It may be appreciated that other discovery protocols may be implemented, for example, Cisco discovery protocol (CDP), any other layer 2 discovery protocol, any layer 3 discovery protocol, etc. LLDP communications from switch 104 to controlled device 108 may include information relating to switch 104, for example, name of switch 104, model, IP address, port A name (the port to which communication is facilitated between switch 104 and controlled device 108), etc. This information may be parsed from the LLDP communication received at controlled device 108 and may be stored in neighbor information 326, as discussed above. Discovery protocol communications may be sent from, for example, switch 104 in periodic intervals, for example, every thirty seconds. If a device receives a discovery protocol communication from two devices at the same time, the communication from the neighbor device with a higher priority may be parsed for information relating to the neighbor device of the higher priority, and the parsed information may be stored in neighbor information 326.

Network interface application may further enable communication 114 (FIG. 1) between controlled device 108 and central controller 102. Communication 114 may include the dynamic name of controlled device 108.

In an alternative embodiment, for example, where controlled device 108 does not include dynamic name application 310, information obtained, for example, through a discovery protocol, or through other processes, for example, sniffing spanning tree packets, may be transmitted from controlled device 108 or switch 104 to the central controller 102. This information may include, for example, identifying information of the controlled device, for example, an IP address of the controlled device, including subnet information, a service set identifier (SSID), a media access control (MAC) address, etc., through which the central controller 102 may determine controlled device 108's location.

In addition, or alternatively, information regarding a neighbor device may be utilized by central controller to identify the controlled device's location. For example, identifying information, for example, the MAC address, of device 106 may be utilized in determining the location controlled devices 110, 112. Thus, information regarding device 106 may be information related to controlled devices 110, 112. In an example, the identifying information of the neighbor device may be extracted from a communication received by central controller 102 and applied to the predefined rules, as discussed herein, in order to determine which group the controlled device 110, 112, should be associated with.

3. Dynamic Name Application

Dynamic name application 310 enables a user to configure a dynamic name definition through, for example a command line interface (CLI). Dynamic name application may be stored, for example, in flash RAM and may be implemented as part of a firmware of the device. As discussed herein, software and firmware may be implemented as machine readable instructions.

The dynamic name definition as configured by the user may be stored, for example, in dynamic name definition 322. The dynamic name definition may incorporate dynamic components, static components, etc., as defined by a user. Static components may be components that do not change regardless of what devices are the neighbors of the device, where the device is located within system 100, etc. Dynamic components may be components that do change depending on the neighbor of the device, where the device is located within system 100, etc. As such, if a device is physically moved from one location within system 100 to another location within system 100, the static components of the name stay the same while the dynamic components of name may change.

Upon start up of controlled device 108, a user, through the CLI, may configure the dynamic name definition. It may be appreciated that the dynamic name definition may be similarly configured for similar devices within the system. For example, all controlled devices may have the same dynamic name definition. This definition may be configured as the same definition of the dynamic name definition of other devices within system 100. For example, the user may configure the dynamic name definition of controlled device 108 as follows:

### Name=Switch <Remote Name> <Remote Port>-AP- <Local Serial Number> <Local IP Address>

In this example, “Switch” and “AP” are static components and will not change when the dynamic name definition is populated. “Remote Name,” “Remote Port,” “Local Serial Number” and “Local IP Address” are dynamic components and will change when the dynamic name definition is populated. As switch 104 is a neighbor device to controlled device 108, Remote Name will be populated with the name of the Switch that controlled device 108 is connected to. Remote Port will be populated with the port name that controlled device 108 is connected to. Local Serial Number will be populated with the serial number of controlled device 108 as assigned by, for example, the manufacturer. Local IP Address will be populated with the IP address assigned to controlled device 108. Thus, the dynamic name may be a user-configurable string of characters that may include information related to controlled device 108 and its neighbor device, switch 104. The population and generation of the dynamic name of the controlled device 108 may be performed by dynamic name application 310. It may be appreciated that the CLI enabling the user to define the name may be enabled by dynamic name application 310 or by a different application within controlled device 108.

As an example, a dynamic name of a device may be as follows: Switch SW_Building3_Floor2-Port A14-APJ88323. Thus, as can be seen from this example, the dynamic name identifies that the controlled device 108 is communicably linked to a switch that is located in building 3, floor 2 at port A14. If controlled device is moved to a new location, the switch information populated in the dynamic component of the controlled device's dynamic name may be updated with the new switch information, thereby identifying the new location.

It may be appreciated that any other type of information that is known about the neighbor device or the controlled device may be used in configuring the dynamic name definition.

By providing for a dynamic name that is generated based on information related to the device, for example, the controlled device 108, and its remote, neighbor, for example switch 104, if the controlled device 108 goes down and looses communication with the central controller, an administrator merely needs to look at the dynamic name of the controlled device 108 in order to ascertain its location. Once the location is known, the administrator can take appropriate steps to restart connectivity with controlled device 108.

In addition, when a device is moved from one location to another location and brought on-line, upon receipt of a discovery protocol communication from a new neighbor device, information regarding the new neighbor device may be extracted from the discovery protocol communication, updated in the neighbor information 326, and a new dynamic name of the device may be generated using the new neighbor information. The new dynamic name of the device may then be communicated to central controller 102 where central controller may update the dynamic name of the device.

If the neighbor of the device is moved, when the device receives a discovery protocol communication from the new neighbor device, upon receipt of a discovery protocol communication from a new neighbor device, information regarding the new neighbor device may be extracted from the discovery protocol communication, updated in the neighbor information 326, and a new dynamic name of the device may be generated using the new neighbor information. The new dynamic name of the device may then be communicated to central controller 102 where central controller may update the dynamic name of the device.

As noted above, discovery protocol communications are sent on a periodic basis. If information within the discovery protocol communication changes, a new dynamic name may be generated. For example, if controlled device 108 and switch 104 were communicating through port A at switch 104, and port A goes down, then switch 104 may establish communication to controlled device 108 through port B. In the next discovery protocol communication from switch 104, port B would be identified as the port through which communication is established. Upon receipt of the discovery protocol communication identifying port B, controlled device 108 may compare the information received in the discovery protocol communication with the information that is stored in neighbor information 326. Any different information may be updated in neighbor information 326. If the dynamic components of the dynamic name definition have changed, then a new dynamic name may be generated by controlled device 108 and the new dynamic name may be communicated to central controller 102. Central controller 102 may then update the dynamic name information of controlled device 108.

Thus, upon receipt of a new discovery protocol communication, the communication is parsed to obtain the neighbor device information. The parsed neighbor device information is then compared with the stored neighbor device information. If any of the information that is parsed from the discovery protocol information is different than the information stored in neighbor information 326, the information stored in neighbor information 326 is updated, and a new, updated dynamic name of the device may be generated. The new, updated, dynamic name includes the updated information that was received from the most recent discovery protocol information. The new, updated, dynamic name may then be communicated to the central controller 102.

If a discovery protocol communication is not received at a device from its neighbor, then the device may assume that it is no longer communicably linked to its neighbor. However, the device may maintain its dynamic name until a discovery protocol communication is received from a new neighbor. As such, a user may determine what device is down based on the neighbor information included in the device's dynamic name.

### Dynamic Name Generation

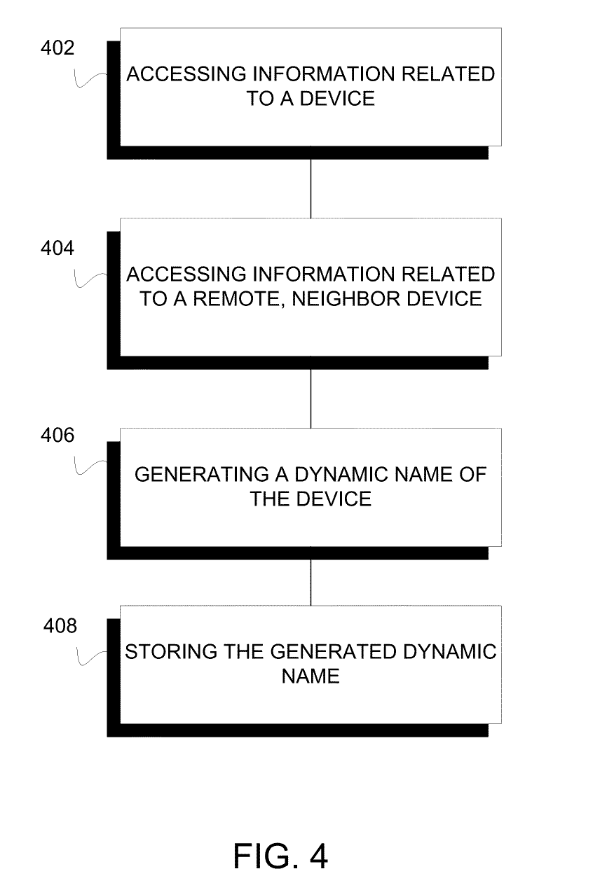

FIG. 4 depicts an example of a flow diagram of a method for generating a dynamic name. It may be appreciated that this method may be performed at any device operating within system 100. As shown in FIG. 4, a device within system 100 may access information related to the device (402). This information may be stored in local information 314 stored in memory 304, and may include information that is provided by a manufacture of the device, an IP address assigned to the device, etc. The device may access information related to a remote, neighbor device (404). This information may be stored in neighbor information 326. The stored neighbor information 326 may be obtained by extracting it from a discovery protocol communication sent, for example, using a layer 2 or layer 3 discovery communication protocol, received at the device from the remote, neighbor device.

A dynamic name of the device may be generated based on the accessed information related to the device and the remote, neighbor device (406). The dynamic name may be generated by accessing a dynamic name definition, where the dynamic name definition may have a static component and a dynamic component. The dynamic component of the dynamic name definition may be populated with the accessed information related to the device and the remote, neighbor device.

The generated dynamic name of the device may be stored (408). The generated dynamic name of the device may be stored in local information 314, specifically dynamic name 324. The generated dynamic name may be transmitted to central controller 102.

The device may receive a discovery protocol communication from a different remote, neighbor device. This may be when the remote, neighbor device has been taken offline and a new, or different, remote, neighbor device is online. Upon receipt of the discovery protocol communication, the device extracting information related to the different remote, neighbor device and stores the information related to the different remote device by updating the corresponding information in neighbor information 326. An updated dynamic name of the device may be generated based on the accessed information related to the device and the information related to the different remote, neighbor device. The generated updated dynamic name may be stored in dynamic name 324 and transmitted to central controller 102.

### Topology Map Generation

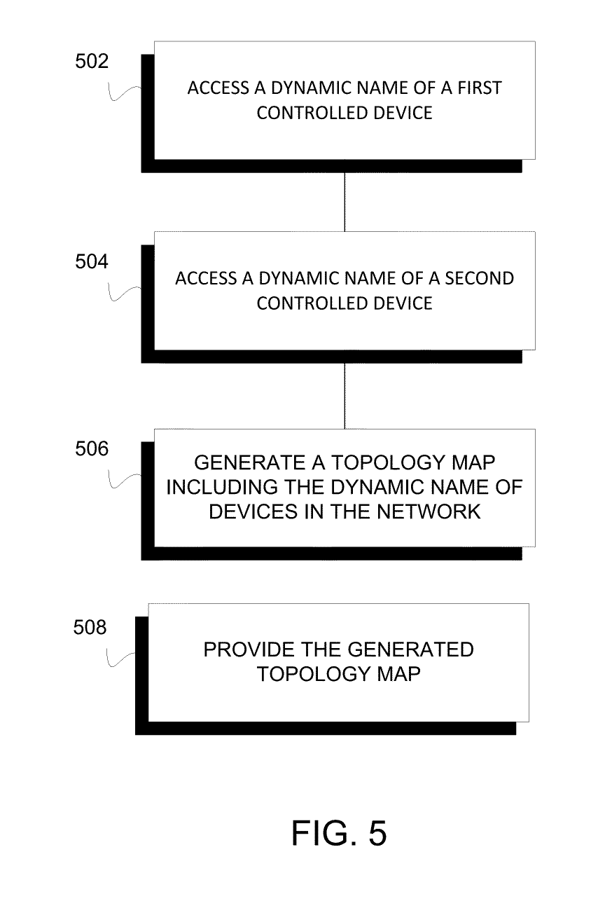

FIG. 5 is a flow diagram of an example of a method performed at central controller 102 for generating a topology map. As shown in FIG. 5, central controller 102 may access, from memory, a dynamic name of a first controlled device. The dynamic name of the first controlled device may include information related to a remote, neighbor device of the first controlled device (502). For example, the first controlled device may be controlled device 108 and remote, neighbor device may be switch 104. The central controller 102 may then access a dynamic name of a second controlled device, the dynamic name of the second controlled device including information related to a remote, neighbor device of the second controlled device (504). For example, the second controlled device may be controlled device 110 and the remote, neighbor of the second controlled device may be switch 106. Using topology application 212, central controller may generate a topology map of a network including the first controlled device and the second controlled device (506). Central controller 102 may then provide the generated topology map (508) by displaying the generated topology map on a display at central controller 102, transmit the generated topology map to another device within system 100, etc.

Central controller may receive a communication from the first controlled device, controlled device 108. The communication may include, for example, an updated dynamic name of the first controlled device. Upon receipt of the communication, the central controller 102 may update, in memory, the dynamic name of the first controlled device with the updated dynamic name of the first controlled device. The generated topology map may be updated with the updated dynamic name of the first controlled device. If a new topology map is generated, the updated dynamic name of the first controlled device will be utilized.

Central controller 102 may determine that communication has been lost to the first controlled device. The central controller may identify the remote, neighbor device of the first controlled device based on the dynamic name of the first controlled device. For example the central controller may parse the dynamic name of the first controlled device in order to ascertain information related to the remote, neighbor device. The central controller 102 may provide a message, for example, by displaying on a display, communicating to another device within system 100, etc., identifying the remote, neighbor device of the first controlled device as having failed.

Central controller 102 may receive a communication from a third controlled device (not shown). The third controlled device may replace the first controlled device, for example, controlled device 108. The communication may include a dynamic name of the third controlled device. Central controller may store the dynamic name of the third controlled device in memory. Central controller may update the topology map by replacing the dynamic name of the first controlled device with the dynamic name of the third controlled device.

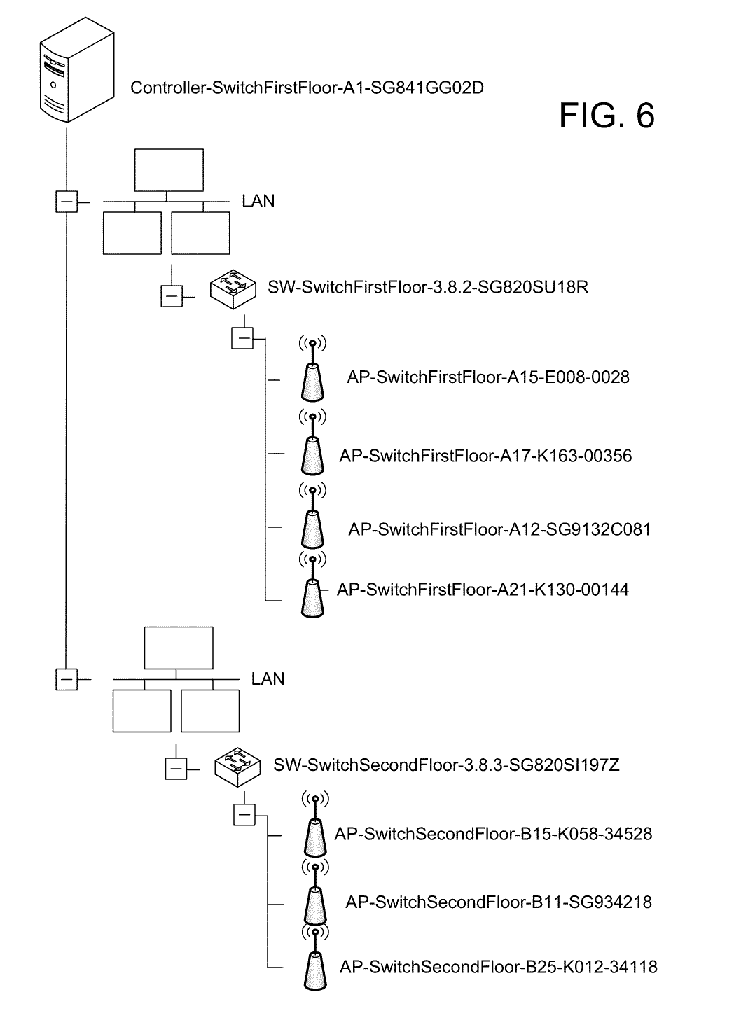

FIG. 6 depicts a diagram depicting an example of a topology map. As can be seen in FIG. 6, the dynamic names of the devices are included in the generated topology map, thereby providing information, for example relative location, physical location, etc., relating to each of the devices within a network system. The dynamic names of the controlled devices depicted in FIG. 6 were generated with the dynamic name definition as follows: AP-<Remote Neighbor Name>-<Remote Port>-<AP Serial Number>. The dynamic name of the central controller device depicted in FIG. 6 was generated with the dynamic name definition as follows: Controller-<Remote Neighbor Name>-<Remote Port>-<Controller Serial Number>. The dynamic names of the switches depicted in FIG. 6 were generated with the dynamic name definition as follows: SW-<Switch Name>-<Software Version>-<Switch Serial Number>.

It may be appreciated that the topology map may be generated where the dynamic name of certain devices are not depicted in the topology map. For example, the central controller's dynamic name may not be depicted in the generated topology map since the location of the central controller is not likely to change and an administrator would know where the device is located. This may be configured using the topology application.

### Central Controller Process Flow

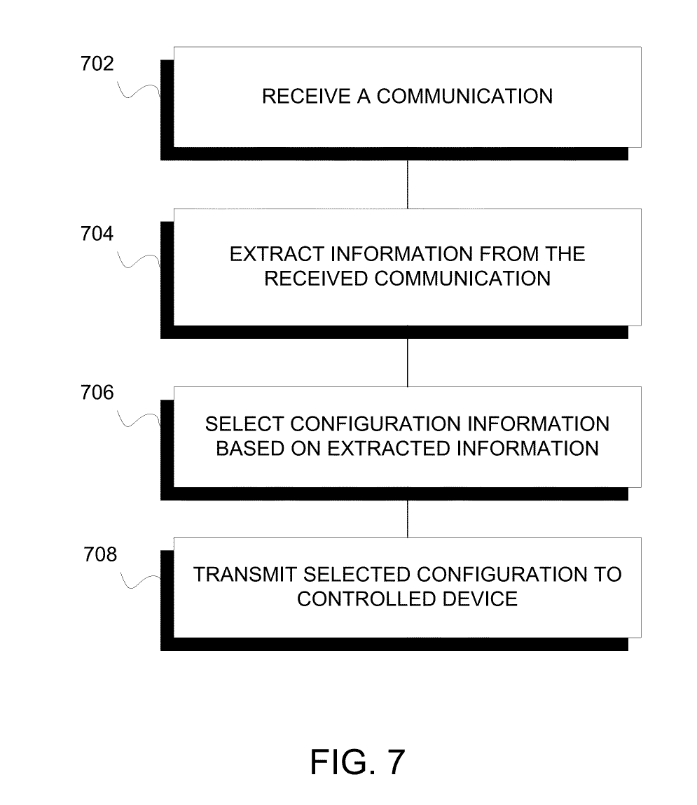

FIG. 7 depicts a flow diagram of the steps performed at the central controller 102 for selecting configuration information. As shown in FIG. 7, a communication is received 702. The communication may include a dynamic name of the controlled device.

Information is extracted from the received communication 704. Where the communication includes the dynamic name of the controlled device, the dynamic name is parsed, for example, by information extractor 212, in order to extract information related to the controlled device. Information related to the controlled device may include location information of the controlled device.

Configuration information may be selected based on the extracted information 706. Where information was extracted from the dynamic name of the controlled device, the extracted information may include location information of the controlled device. The location information may be passed, for example, to configuration information selector 214. Configuration information selector 214 may access configuration information 207 in secondary memory 206 and select the appropriate configuration information based on the location information of the controlled device. For example, where the extracted information from the dynamic name of the controlled device was Building A, configuration information selector 214 may select configuration information 1.

The selected configuration information may be transmitted to the controlled device 708.

In an alternative embodiment, where the communication does not include the dynamic name of the controlled device, but includes identifying information of or information related to the controlled device, for example, the IP address of the controlled device, including the subnet where the controlled device is located, the identifying information may be extracted from the communication. For example, where the identifying information is an IP address, the subnet information may be extracted. Predefined rules, as discussed above, may be utilized in order to determine which group the controlled device belongs to based on the extracted subnet. The configuration information may be selected based on the extracted location of the controlled device and transmitted to the controlled device. It may be appreciated that other identifying information may be extracted from the communication, for example, a service set identifier (SSID) of the controlled device or a neighbor device, a media access control (MAC) address of the controlled device or a neighbor device, etc. Based on the extracted information, and the rules as defined by the administrator, the controlled device's location may be determined and thus the controlled device may be associated with one of the groups in the network. The association may then be stored, for example, in secondary storage.

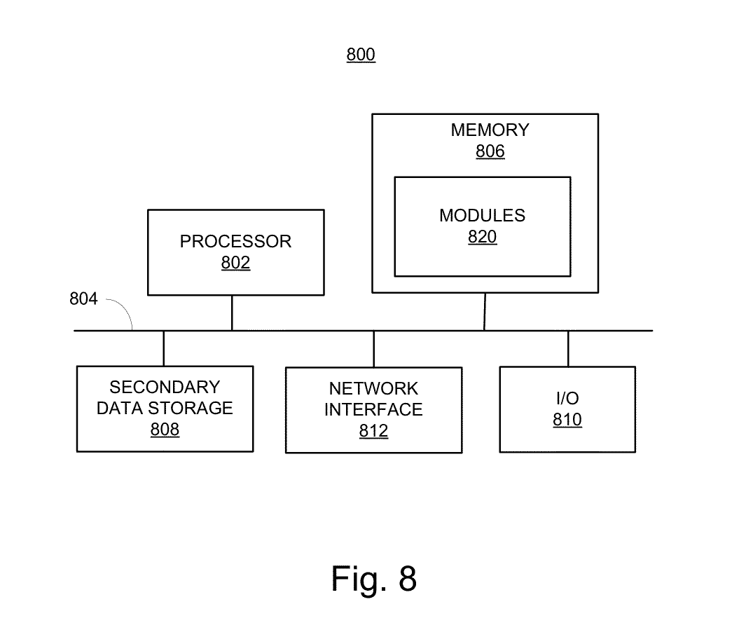

FIG. 8 shows a computer system that may be used with the examples described herein. The computer system represents a generic platform that includes components that may be in a server or another computer system. The computer system may be used as a platform for the apparatus 102. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 802 that may implement or execute machine readable instructions performing some or all of the methods, functions and other processes described herein. Commands and data from the processor 802 are communicated over a communication bus 904. The computer system also includes a main memory 806, such as a random access memory (RAM), where the machine readable instructions and data for the processor 802 may reside during runtime, and a secondary data storage 808, which may be non-volatile and stores machine readable instructions and data. The memory and data storage are examples of computer readable mediums. The memory 806 may include modules 820 including machine readable instructions residing in the memory 806 during runtime and executed by the processor 802. The modules 820 may include the information extractor 212 and configuration information selector 214 of the apparatus shown in FIG. 2.

The computer system may include an I/O device 810, such as a keyboard, a mouse, a display, etc. The computer system may include a network interface 812 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

We claim:

1. A method to transmit configuration information to a controlled device in a network, the method comprising:
receiving a dynamic name of the controlled device;
extracting information related to the controlled device from the dynamic name of the controlled device;
selecting one of a plurality of configuration information based on the extracted information; and
transmitting the selected configuration information to the controlled device.

2. The method of claim 1, further comprising:
defining, utilizing a script, a plurality of groups in the network based on a plurality of physical locations in the network.

3. The method of claim 2, further comprising:
for each of the plurality of defined groups in the network, associating one of a plurality of configuration information in a memory.

4. The method of claim 2, further comprising:
associating the controlled device to one of a plurality of groups based on the extracted information and a predefined rule.

5. The method of claim 1, wherein the controlled device is configured utilizing the transmitted configuration information.

6. An apparatus, comprising:
a memory, to store a plurality of configuration information, each of the plurality of configuration information associated with a location-based group in a network;
a network interface to receive a communication from a controlled device, the controlled device to be installed in a network;
an information extractor to extract information related to the controlled device from the received communication; and
a configuration information selector to select one of a plurality of configuration information based on the extracted information;
wherein the network interface is to transmit the selected configuration information to the controlled device for installation at the controlled device.

7. The apparatus of claim 6, the memory is to further store a script to define a plurality of groups in the network based on a plurality of locations in the network, wherein each of the plurality of configuration information is associated with one of the plurality of groups.

8. The apparatus of claim 6, wherein the received communication includes a dynamic name of the controlled device, and the extracted information is extracted from the received dynamic name of the controlled device.

9. The apparatus of claim 6, wherein the information related to the controlled device is identifying information of a neighbor device.

10. The apparatus of claim 6, wherein the configuration information selector is to select one of the plurality of configuration information based on the Internet Protocol subnet on which the controlled device is installed.

11. The apparatus of claim 6, the configuration information selector further to enable creation of a plurality of rules, the plurality of rules to define which group the controlled device should be associated with based on extracted information.

12. A non-transitory machine-readable storage medium for storing instructions, executable by a processor, to:
receive a communication;
extract information related to a controlled device to be installed in a network from the received communication;
select one of a plurality of configuration information based on the extracted information, each of the plurality of configurations associated with one of a plurality of groups, each of the groups associated with a location in the network; and
transmit the selected configuration information to the controlled device for installation at the controlled device.

13. The non-transitory machine-readable storage medium of claim 12, wherein the received communication includes a dynamic name of the controlled device, and the extracted information is extracted from the received dynamic name of the controlled device.

14. The non-transitory machine-readable storage medium of claim 12, wherein the communication is a discovery communication.

15. The non-transitory machine-readable storage medium of claim 12, wherein the processor is to select one of the plurality of configuration information based on identifying information of the controlled device, including at least one of an Internet Protocol subnet on which the controlled device is installed, a service set identifier (SSID) of the controlled device, a SSID of a neighbor device, a media access control (MAC) address of the controlled device, and a MAC address of a neighbor device.

16. The non-transitory machine-readable storage medium of claim 12, the processor further to:
enable creation of a script, the script to define a plurality of rules to determine which group the controlled device should be associated with based on extracted information.
